(19) United States
(12) Patent Application Publication
(10) Pub. No.: US 2007/0266831 A1
(43) Pub. Date: Nov. 22, 2007

(54) Housing for a Portable Tool

(76) Inventors: Wolf Matthias, Stuttgart (DE); Marcin Rejman, Waiblingen (DE)

Correspondence Address: MICHAEL J. STRIKER, 103 EAST NECK ROAD, HUNTINGTON, NY, 11743, US

(21) Appl. No.: 11/573,921

(22) PCT Filed: Apr. 18, 2006
(86) PCT No.: PCT/EP06/61622

§ 371 Date: Feb. 19, 2007

(30) Foreign Application Priority Data
May 17, 2005 (DE) 102005022681.7

(51) Int. Cl. B25B 23/16

(52) U.S. Cl. 81/177.1; 81/489

(57) ABSTRACT

The invention relates to a housing element for a portable tool, which consists of at least two types of material (PA, TPE) and includes an information-carrying identification element (10). The invention is characterized in that the identification element (10) produced of a first type of material (PA) engages through an area (12) produced of a second type of material (TPE).

### RELATED ART

The present invention relates to a housing element for a hand-held power tool according to the preamble of claim 1.

A housing element for a hand-held power tool that is composed of two types of material and includes an information-containing identification element is already known. The identification element is made of a first type of material and is bonded—as an adhesive plate—to a housing shell part, which is made of a second type of material.

### ADVANTAGES OF THE INVENTION

The present invention relates to a housing element for a hand-held power tool, which is made of at least two types of material and includes an information-containing identification element.

It is provided that the identification element, which is made of a first type of material, extends through a region made of a second type of material. As a result, it is possible to obtain a robust, fully wear-resistant, high-quality identification element for a hand-held power tool that includes the aforementioned housing element. In addition, the region made of the second type of material can be designed—via the identification element—such that it is particularly easy to grip, particularly when the identification element is designed as a raised profile. The hand-held power tool is therefore safer to operate.

The identification element extends through the region made of the second type of material when most of it, i.e., at least 90%, is enclosed by the second type of material. Various materials can be considered to be the same type of material if they have at least one obviously similar property.

A slip-resistant, impact-absorbing housing for a hand-held power tool—that also poses less risk of injury—can be attained when at least one of the material components has high elasticity. Materials with high elasticity are, in particular, materials with E modules below 2000 GPa, e.g., plasticized PVC or flexible polyurethane foam. Risk of injury can be reduced, in particular, when the elastic material components cover at least part of a hard material component that is made, e.g., of hard plastic or metal.

The hand-held power tool can be labeled in a manner that allows it to be identified at a distance when the two types of material have different colors. Particularly advantageously, the different colors are complementary, such as green and red.

An optical and tactile differentiation can also be attained when the two materials have different surface structures.

A particularly high level of gripping comfort can be attained when at least one of the types of material is a soft material that contains a high portion of natural rubber, e.g., a material of the type known by the name “Softgrip”. Advantageous thermal insulation can also be attained when at least one of the types of material includes thermally-insulating gas inclusions.

A particularly form-fit bonded connection between the first type of material and the second type of material can be attained when the identification element, which is made of the first type of material, is enclosed by an injection-molded coating of the second type of material. Additional manufacturing steps can therefore be avoided when the two types of material are joined in a two-component injection molding process.

As an alternative, the manufacture of the housing element for the hand-held power tool can be realized with a particularly small initial investment when the second type of material is bonded with the first type of material.

By combining the identification element, which is made of the first type of material, with the region made of the second type of material such that they form a continuous surface, it is possible to prevent edges from striking each other at a transition between the types of material, thereby also resulting in good cleaning properties. In this context, the term “continuous” should be understood to mean a smooth surface. A particularly high-quality impression can be made when the first type of material and the second type of material are processed in an intarsian manner.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 shows a hand-held power tool with a housing element for a hand-held power tool that includes an identification element,

FIG. 2 shows the housing element for the hand-held power tool with the identification element in FIG. 1,

FIG. 3 shows the housing element for the hand-held power tool in FIGS. 1 and 2 in an exploded view with separated components made of different types of material, and

FIG. 4 is a sectional view along the line IV-IV through the housing element for the hand-held power tool in FIG. 2.

### DESCRIPTION OF THE EXEMPLARY EMBODIMENTS

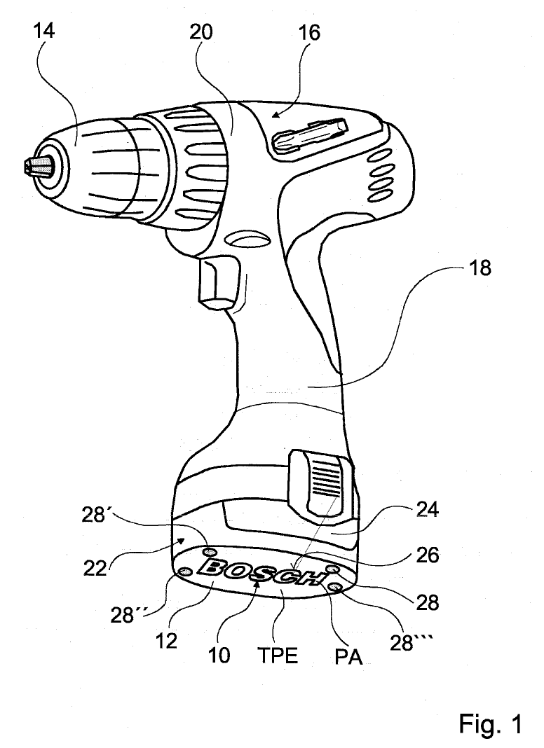

FIG. 1 shows an electric hand-held power tool, which is designed as a cordless screwdriver and includes a housing 16 made of plastic. Housing 16 includes a cigar-shaped body 20, in which a drive motor for driving a screwdriver chuck 14 is located, and it includes a handle 18—to which a rechargeable battery pack 22 is detachably fastened—on the end opposite to body 20.

Rechargeable battery pack 22 includes a housing element for a hand-held power tool designed as a lower housing shell, which is made of two types of material, PA and TPE.

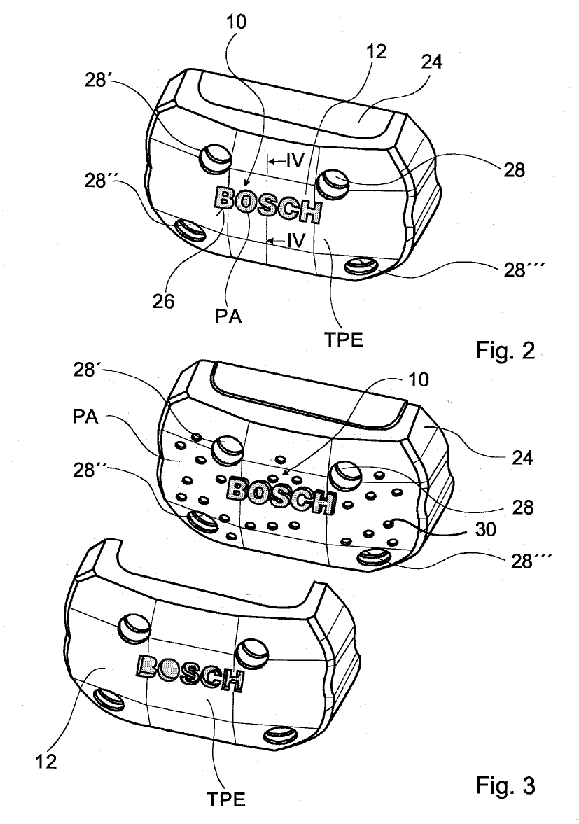

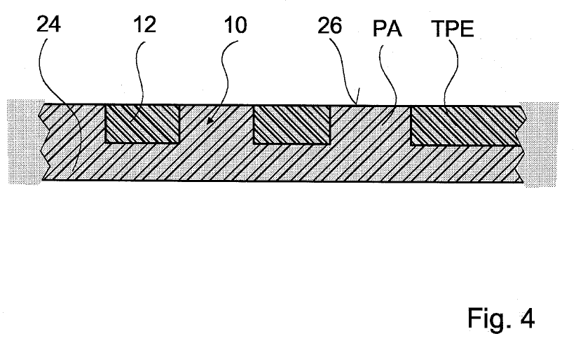

FIG. 2 shows the housing element for the hand-held power tool in a separate depiction and separated from the rest of housing 16. On an underside, which faces away from handle 18 when rechargeable battery pack 22 is attached, the housing element for the hand-held power tool includes an identification element 10 designed as a lettering motif, which is made of a first type of material (PA) and extends through a region of a second material type (TPE). In the present exemplary embodiment, the first type of material, PA, is a red polyamide with a smooth surface structure and an elasticity module of approximately 2 GPa, while the second type of material, TPE, is a black, elastic, thermoplastic elastomer with a high percentage of natural rubber, an easily gripped surface structure, and an elasticity module of a few hundred MPa.

As the first step in the manufacture of the housing element for the hand-held power tool, a carrier part 24 is cast using the first type of material (FIG. 3). Identification element 10 is designed as a relief-like profile that is raised above the surface of carrier part 24.

Identification element 10 and a region 12 surrounding identification element 10 are then coated with the second type of material, TPE. A thickness of the applied material layer of the second type of material, TPE, in region 12 is the same as the height of the profile of identification element 10. As a result, after coating, identification element 10—which is made of first material type PA—and region 12 made of second material type, TPE, form one continuous surface 26.

To support a bond between region 12 made of second material type TPE and carrier part 24, the latter includes a large number of small recesses 30. The housing element for the hand-held power tool also includes four screw holes 28-28′″ located in an edge region of the underside for attaching the housing element for the hand-held power tool with a further housing part 28 (FIG. 1) of rechargeable battery pack 22 using screws.

The application of the coating of second material type, TPE, around identification element 10 can take place independently of the manufacture of carrier part 24 or within the framework of a two-component injection molding procedure by manufacturing carrier part 24 within the same context as region 12.

What is claimed is:

1. A housing element for a hand-held power tool, which is composed of at least two types of material (PA, TPE) and includes an information-containing identification element (10),
wherein
the identification element (10), which is made of a first type of material (PA), extends through a region (12) made of a second type of material (TPE).

2. The housing element for a hand-held power tool as recited in claim 1,
wherein
the identification element (10) is designed as profile that is raised above a surface of a carrier part (24).

3. The housing element for a hand-held power tool as recited in claim 1, characterized by the fact that at least one of the types of material (TPE) is highly elastic.

4. The housing element for a hand-held power tool as recited in claim 1,
wherein
the two types of material (PA, TPE) are different colors.

5. The housing element for a hand-held power tool as recited in claim 1,
wherein
the two types of material (PA, TPE) have different surface structures.

6. The housing element for a hand-held power tool as recited in claim 1,
wherein
at least one of the types of material (TPE) is a soft material.

7. The housing element for a hand-held power tool as recited in claim 1,
wherein
at least one of the types of material (TPE) contains a high percentage of natural rubber.

8. The housing element for a hand-held power tool as recited in claim 1,
wherein
the identification element (10), which is made of the first type of material (PA), is enclosed by an injection-molded coating of the second type of material (TPE).

9. The housing element for a hand-held power tool as recited in claim 1,
wherein
the two types of material (PA, TPE) are joined in a two-component injection-molding process.

10. The housing element for a hand-held power tool as recited in claim 1,
wherein
the second type of material (TPE) is bonded with the first type of material (PA).

11. The housing element for a hand-held power tool as recited in claim 1,
wherein
the identification element (10), which is made of the first type of material (PA), combined with the region (12), which is made of the second type of material (TPE), form a continuous surface (26).

12. A hand-held power tool with a hand-held power tool handle device as recited in claim 1.
